(19) United States
(12) Patent Application Publication
(10) Pub. No.: US 2005/0128054 A1
(43) Pub. Date: Jun. 16, 2005

(54) Method, system, and apparatus to identify and transmit data to an image display

(76) Inventor: Jeff Glickman, Las Vegas, NV (US)

Correspondence Address: KOLISCH HARTWELL, P.C., 520 S.W. YAMHILL STREET, SUITE 200, PORTLAND, OR, 97204, US

(21) Appl. No.: 11/012,626

(22) Filed: Dec. 14, 2004

Related U.S. Application Data
(60) Provisional application No. 60/530,441, filed on Dec. 16, 2003.

(51) Int. Cl. G08B 5/22

(52) U.S. Cl. 340/7.2

(57) ABSTRACT

A method, system, and apparatus for processing an image, including image data, is disclosed, wherein, in one embodiment, the method includes sending regions of an image in which the image has changed from one frame to another. Regions of the image that have changed are identified and transmitted, such as, for example, to reduce bandwidth requirements and increase image update rates.

### CROSS-REFERENCE TO RELATED APPLICATION

The present application claims priority from U.S. Provisional Patent Application Ser. No. 60/530,441 filed Dec. 16, 2003, hereby incorporated by reference in its entirety for all purposes.

### TECHNICAL FIELD

The present disclosure relates generally to apparatus, systems and methods for identifying and transmitting data, and more specifically, apparatus, systems and methods for identifying and transmitting image data to a device.

### BRIEF DESCRIPTION OF THE DRAWINGS

The disclosure is illustrated by way of example and not by way of limitation in the figures of the accompanying drawings, in which the like references indicate similar elements and in which:

FIG. 1 is a schematic view of an image data processing system according to a first embodiment of the present disclosure.

FIG. 2 is a flow diagram of a method of processing image data according to another embodiment of the present disclosure.

FIG. 3 is a schematic representation of the image capture.

FIGS. 4A-4C are illustrations of operation according to one example embodiment.

### DETAILED DESCRIPTION

Briefly, images can be transmitted from one device, such as a display device, to another using various approaches, such as in the area of image display and projection systems. In the example of streaming video, a series of images can be transmitted, one at a time, to allow display of video images. However, since this approach can require significant transmission bandwidth, different approaches can be taken to reduce the amount of information that needs to be transmitted.

One approach to reduce the amount of information transmitted identifies a single region, or portion of the image, to be transferred. The identified region is a rectangle that is selected to be large enough to encompass all of the areas of the image in which the individual pixels have changed. In this way, it is possible to transmit less than the entire image when the image is updated. Thus, in the case of the image being video data, the video data can be transmitted without requiring as much bandwidth and computational compression.

However, there may be various complications which arise with the above-approach. For example, if the image is frequently changing in the bottom right hand corner of the screen (e.g., due to a clock changing every second, or Minute), and also frequently changing in the upper left hand corner of the screen (e.g., due to manipulation of a mouse), then the selected region can be virtually the entire image. As such, little bandwidth improvement may be possible. This can further result in wasted computational processing, since a majority of the image compressed and transferred may not be changing. In other words, this can negatively affect the real-time compression and transmission of some types of image data.

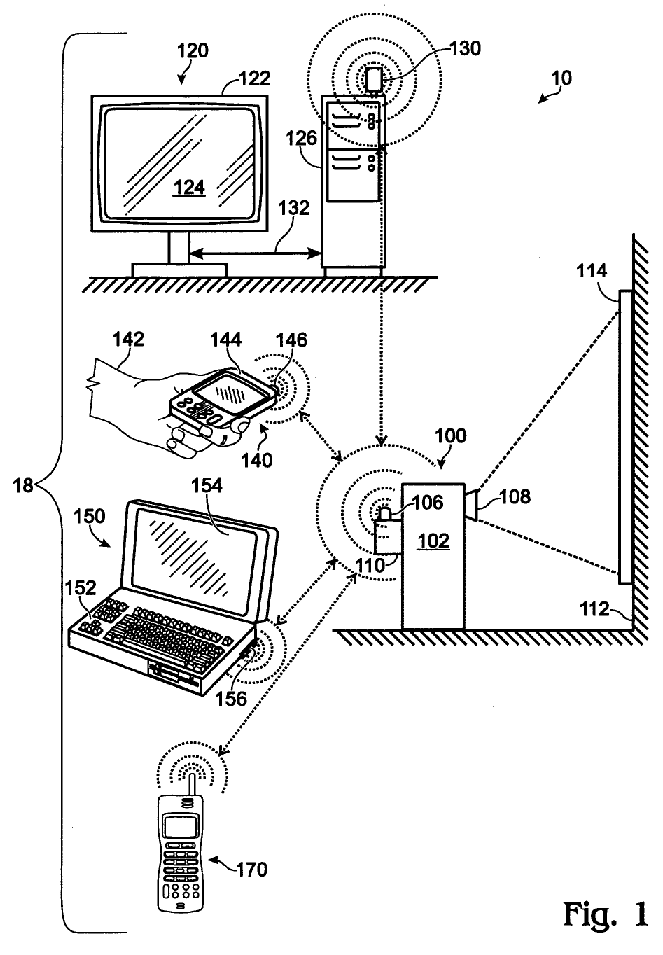

Referring now to the figures, FIG. 1 shows, generally at 10, a schematic depiction of an image processing system according to one embodiment of the present disclosure. An image can include a picture, a presentation, a reproduction of the form of a person or object, or a sculptured likeness, or a vivid description or representation, or a figure of speech, especially a metaphor or simile, or a concrete representation, as in art, literature, or music, that is expressive or evocative of something else, or portions or modifications thereof. Image processing system 10 includes a projection device 100 configured to display an image on a viewing surface, such as screen 114, mounted on wall 112. Projection device 100 is shown including a body 102; however in some embodiments projection device 100 may be incorporated in another device. Projection device 100 further may include a projection element or lens element 108 configured to project the image on to the viewing surface. In some embodiments, the viewing surface may be external of or integrated within the projection device.

Projection device 100 may be any suitable type of image-display device. Examples include, but are not limited to, liquid crystal display (LCD) and digital light processing (DLP) projectors. Furthermore, it will be appreciated that other types of display devices may be used in place of projection device 100. Examples include, but are not limited to, television systems, computer monitors, etc. Furthermore, various other types of surfaces could be used, such as a wall, or another computer screen.

Image processing system 10 also includes an image-rendering device 110 associated with projection device 100, and one or more image sources 18 in electrical communication with image-rendering device 110. For example, the communication can be wireless, through antenna 106 coupled to the image-rendering device 110 (as shown) or to projection device 100. In an alternative embodiment, wired communication can also be used. Image-rendering device 110 is configured to receive image data transmitted by image sources 18, and to render the received image data for display by projection device 100. Image-rendering device 110 may be integrated into projection device 100, or may be provided as a separate component that is connectable to the projection device. An example of a suitable image-rendering device is disclosed in U.S. patent application Ser. No. 10/453,905, filed on Jun. 2, 2003, which is hereby incorporated by reference for all purposes. In still another alternative embodiment, antenna 106 can be integrated in a data transfer device, such as a card, that is inserted into image-rendering device 110. Also, in one example, the device 100 contains computer readable storage media, input-output devices, random access memory and various other electronic components to carry out operations and calculations.

Image-rendering device 110 is capable of receiving various types of data transfer devices. Data transfer devices can be adapted to provide an image, presentation, slide or other type of data to be transferred to image-rendering device 110 from an independent source, e.g. an external computer or a mass storage device. An external computer includes any suitable computing device, including, but not limited to, a personal computer, a desktop computer, a laptop computer, a handheld computer, etc.

Data transfer devices enable image-rendering device 110 to receive images from multiple sources. As stated above, the data transfer device may be a card, an expansion board, an adapter or other suitable device that is adapted to be plugged into image-rendering device 110.

In some embodiments, any number of different data transfer devices may be interchangeably received within image-rendering device 110. For example, a data transfer device may be a network interface card, such as a wired network card, or a wireless network card. Specifically, a wired network card may include an IEEE 802.3 standard wired local area network (LAN) interface card, e.g. Ethernet, 100BASE-T standard (IEEE 802.3u) or fast Ethernet, IEEE 802.3z or gigabit Ethernet, and/or other suitable wired network interface. A wireless network card may include a wireless LAN card, such as IEEE 802.11a, 802.11b, 802.11g, 802.11x, a radio card, a Bluetooth radio card, a ZigBee radio, etc.

Each network interface card, regardless of type, enables communication between device 110 and an independent source, e.g. a remote computer, server, network, etc. This communication allows an image stored on the independent source (e.g., any of the image sources indicated at 18) to be transmitted to image-rendering device 110. Examples of specific implementations of different network interface cards within image-rendering device 110 are described in more detail below.

As illustrated in FIG. 1, the projection system projects an image (in one example, a lighted image) onto screen 114. Such a system can be used in various situations such as, for example: in meeting rooms, schools, or various other locations.

Continuing with FIG. 1, image sources 18 may include any suitable device that is capable of providing image data to image-rendering device 110. Examples include, but are not limited to, desktop computers and/or servers 120, laptop computers 150, personal digital assistants (PDAs), such as hand-held PDAs, 140, mobile telephones 170, etc. Furthermore, image sources 18 may communicate electrically with image-rendering device 110 in a variety of ways, such as via wireless communication or wired communication. In the depicted embodiment, each image source 18 communicates electrically with image-rendering device 110 over a wireless network (dashed arrow lines). However, image sources 18 may also communicate over a wireless or wired direct connection, or any combination thereof.

Specifically, personal computer 120 is shown with a monitor 122 having a screen 124. In addition, the personal computer is shown as a desktop computer with a device 126 having various accessories and components such as, for example: a disc drive, a digital video disk (DVD) drive, and a wireless communication device 130. Note also that the device 126 communicates with the screen 124 via a wired link 132. However, communication between the monitor and the device 126 could also be wireless.

Next, PDA 140 is also shown in a person's hand 142. PDA 140 has a screen 144 and a wireless communication device 146. Laptop computer 150 is also shown with a keyboard 152 and a flat screen 154. In addition, the laptop computer 150 has a wireless communication device 156.

As indicated by the arrows in FIG. 1, each of the personal computer 120, personal device assistant 140, and laptop computer 150 communicate via the wireless communication devices with the projector device 100. The mode of wireless communication can be any of the standardized wireless communication protocols. Also note that any of the devices of FIG. 1 can show images on their respective screens. Further, any of the devices of FIG. 1 can transmit regions of change in images, as discussed in more detail below.

As such, any of these can represent an image display device, which, in one example, is any device displaying an image. These screens can be either color or black and white. The types of images displayed on these screens can be of various forms such as, for example: the desktop, JPEG, GIF, MPEG, DVD, bitmap, or any other such file form. Thus, in one particular example, the user's desktop image is transported and displayed via an image display device as described in more detail below.

As indicated in more detail below, each of the devices 120, 140, and 150, or 170 contain computer code to capture images from the screen, and transmit these images via the wireless communication devices to the projector device 100. Then, projector device 100 projects these received images onto screen 114.

Note that the above is just one example of this configuration. The system can include multiple computers, multiple PDAs, or contain only one of such devices, or only a single image source. Further, the projection system 100 can be made of any number of components, and the system illustrated in FIG. 1 is just an example.

As discussed above, image sources 18 may be configured to generate raw data files from images displayed on a screen of the image source, and then to compress the files using a fast compression technique, such as a Lempel-Ziv-Oberhumer (LZO) compression technique, for transmission to image-rendering device 110 in real-time. This allows any image displayed on a screen of an image source 18 (or any raw data file on an image source 18) to be transmitted to and displayed by projection device 100.

Alternatively or additionally, image sources 18 may be configured to provide any suitable type of image data to image-rendering device 110, for example, JPEG, MPEG and other pre-compressed files. The term “pre-compressed” refers to the fact that files in these formats are generally not compressed from raw image files in real-time for immediate transmission, but rather are compressed at some earlier time and stored on image sources 18.

Typically, raw image data files generated by an image source 18 are generated in whatever color space is utilized by the image source. For example, where the image source is a laptop or desktop computer, the raw image data files may be generated in an RGB color space. However, it may be advantageous to change color spaces to match the color characteristics of projection device 100, or to provide increased data compression. Thus, the image sources 18 may be configured to convert the raw image data to a device-independent color space before compressing and transmitting the data to image-rendering device 110. However, depending on the processing capacity, it is also possible to maintain current color spaces and avoid unnecessary conversion. Note that the term “file” is not necessarily a “file” residing on a disk drive or on other media. Rather, it can include a raw image without a header located in a buffer, for example.

When using color space conversion, the images can be transmitted by first sampling the displayed screen image on the sending device (e.g. on screen 124 of personal computer 120). Note however, that color space conversion can be included, or deleted, as desired.

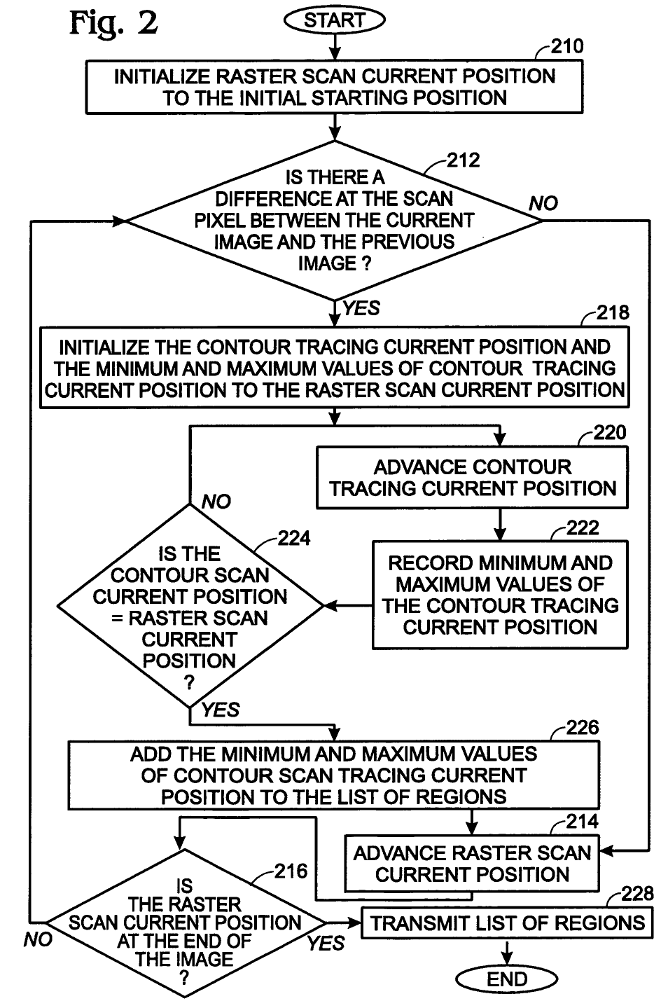

In general terms, according to one example approach, a complete image on the screen is sampled. This screen image is sampled at predetermined intervals (e.g. thirty times per second) and repeatedly sent to the projection device 100. However, to accomplish the image transfer without requiring as much bandwidth, or as much compression on the sending device, as described in more detail below with particular reference to FIG. 2, the entire image is not sent in each transmission. Rather, only selected regions of the screen where the image has changed by a predetermined threshold are sent.

Note that interlacing can also be used in an alternative embodiment. Specifically, the regions are selected on an interlaced image, such that horizontal (or vertical) lines are analyzed and regions within them identified. Further, each region can be transmitted as soon as it is identified. Alternatively, a group of regions can be sent after an entire image, or portion of an image is sent. Still further, multiple sets of regions can be identified at different resolutions to provide complete screen updates that progressively reach higher resolution. In this way, it can be possible to provide complete screen updates even when there are numerous regions identified and transmitted.

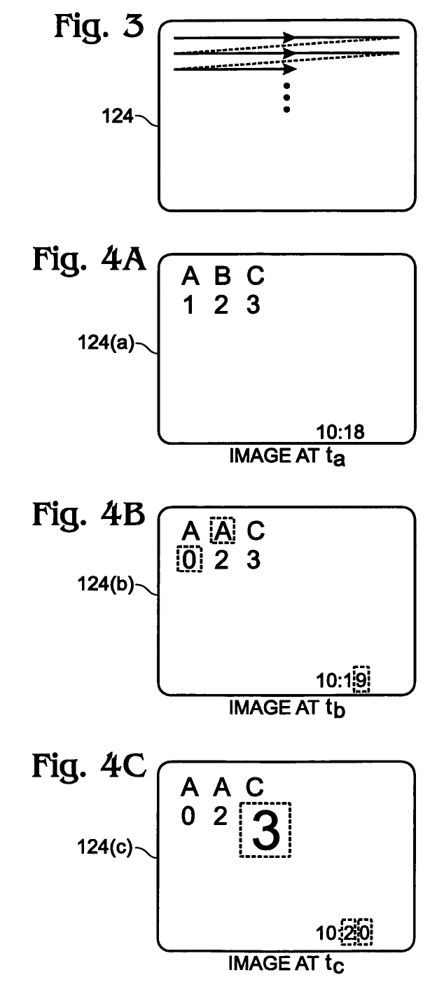

Referring now specifically to FIG. 2, a flow chart illustrates a routine for identifying and capturing regions of change in an image is described. First, in step 210, the routine performs a raster/scan of a selected pixel and the image. In one example, the routine initializes the current position of the raster scan (Raster Scan Current Position) to the initial starting position. As shown in more detail with regard to FIG. 3, the raster performed in this example traverses horizontally across the screen in the same direction, starting from the top of the screen and working to the bottom of the screen. Thus, in one example embodiment, the raster scan starts at pixel location (0,0), the top left corner of the display screen, and processes pixels sequentially, horizontally, from left to right. Upon reaching the end of the horizontal scan, the raster retraces from right to left (known as the horizontal retrace) down to the next line. The process repeats until all horizontal lines are processed. Alternatively, the raster performed in this example could traverse horizontally across the screen in a back and forth motion, starting from the top of the screen and working to the bottom of the screen. Furthermore, various other rasters could be used, such as starting from the bottom of the screen and working up or starting from the left hand side of the screen and working to the right hand side of the screen moving vertically.

Next, in step 212, the routine determines whether there is a difference in the scanned pixel from the corresponding pixel in the previously sampled image. There are various ways to determine a difference in the image. For example, a difference can be found using binary operations, such as one complement and/or twos complement bit processing. The type of difference formed can also be selected depending on the number of components per pixel and their specific representation. In one example, the difference used is the norm computed on the 3 component vector of ones complement differences.

Note also that in the case using a 3 component vector of ones complement differences, any difference in the pixel will be identified as a change in the image. However, to reduce the amount of data transmission, it is possible to identify a difference only if the difference is greater than a threshold value, for example a preselected or predetermined value. Use of threshold values may be compared to the norm value, or a threshold for each color value could be used, if desired. This could be helpful if certain image changes in some color spaces were deemed more beneficial for transmission than other changes in other color spaces.

When the answer to step 212 is NO, the routine continues to step 214. In step 214, the routine advances the Raster Scan Current Position to the next pixel as illustrated in FIG. 3.

When the answer to step 212 is YES, the routine continues to step 218 to start the contour tracing in which the routine traces the outer contour of the identified difference(s) in the images. In one example, the contour tracing finds the complete set of boundary edge pixels surrounding a change in the image identified in step 212 resulting in a closed polygon. The shape of the contour is thus the resulting shape encompassing a change, or changes, in the image. However, in an alternative approach, the routine could perform a trace in a rectangular pattern. However, other shapes, such as triangles or parallelograms could also be used, if desired. Further, the contour tracing defines the size of the images, which can vary depending on how the image changes.

Specifically, in step 218, the current position of the contour tracing (Contour Tracing Current Position) is initialized to the Raster Scan Current Position. Further, the minimum and maximum values of the Contour Tracing Current Position are initialized to the Raster Scan Current Position. Note that, as discussed above, the contour tracing follows the outside edge of a change region, resulting in a closed polygon (or bounding box), in one example. The maximum and minimum excursions in the x (horizontal) and y (vertical) direction during the contour trace on a given region define the bounding box of the change region and thereby its size.

Next, in step 220, the routine advances the Contour Tracing Current Position to thus continue tracing the identified difference between images. Then, in step 222, the routine records the Minimum and Maximum Values of the Contour Tracing Current Position. Then, in step 224, the routine determines if the Contour Scan Current Position is equal to the Raster Scan Current Position. If so, the routine continues to step 226. Otherwise, the routine returns to step 220 to continue the contour tracing. As a result, it is possible to create a closed polygon to guarantee that the traced region is completely enclosed. However, it is not required that the region be completely enclosed in this way.

In step 226, the routine then adds the Minimum and Maximum Values of the Contour Scan Tracing Current Position to the list of the regions identified to have changed pixels from one image to another, thereby providing information indicating the traced contours. From step 226, the routine continues to step 214, discussed above, where the routine advances the Raster Scan Current Position to the next pixel as illustrated in FIG. 3.

From a YES in step 216, the routine continues to step 228, where the information on the changed image for the selected regions is transmitted to the projection device 100. Note that the information regarding the identified changed regions can be processed by other algorithms including but not limited to: being compressed using various compression algorithms before being transmitted from the personal computer 120 to the projection device 100. In this example, the routine takes original RGB images from the source (e.g. personal computer 120) and forms a difference as a ΔRΔGΔB image. Also in this example, the input image is from a frame buffer. More specifically, the frame buffer represents a differential buffer indicating a differential between multiple frame samples.

As such, as described above in step 212, the differential buffer would contain zero (in this example it would be (0,0,0)) when there is no change in the particular pixel at issue. In addition, the differential between multiple and successive screen images from the source device (which could be formed from a scan of the entire screen, known as a screen scrape) is one example method for generating the differential buffer. Note also that the RGB image, in this example, is a 24-bit RGB image having three interleaved planes, although RGB images without interleaved planes could also be used. The data can be of the form having three sequential bytes (r,g,b), or in another order, such as (b,g,r). If any of the bytes are non-zero, a bound edge is identified for generating the contour.

In this way, according to the routine of FIG. 2, it is possible to split the differential image into separate image(s) for later transmission in a more efficient way. In one example, the routine can utilize as many regions as necessary to capture all of the differential changes from image to image. Alternatively, a fixed number of regions could also be utilized. Furthermore, even when using varying numbers of regions, a fixed maximum region number can be selected.

Not only can the number of regions be varied, but in another example, the size of the regions can vary depending on the changes in the images from one to another. Further, the size of the regions can be selected based on the size of the differential between images. In another example, the size of the regions can further be based on the colors, and color variations, in the image and between frames of the image. Specifically, in one aspect, the regions are minimized to be as small as possible to capture the changes in the image while having as many regions as possible. Alternatively, the regions can be of a fixed size.

The operation of the above example routine can be thought of as reading data representing an image, and then identifying at least two spatially separated regions in said image which differ from a previously read image; and then transmitting data from said at least two regions to the device. In other words, although the above routine moves through an image pixel by pixel, this is just an example approach. Alternatively, an entire image can be compared with a previously read image to identify at least two regions of change.

Referring now to FIGS. 4A-4C, example operation according to the routine described in FIG. 2 is illustrated. In FIG. 4A, the image 124(a) illustrates a display having three letters and three numbers in the upper left hand corner and a clock time in the lower right hand corner. Image 124(a) represents an image captured from a screen sample at time (tₐ). In FIG. 4B, the image 124(b), illustrates the next image sampled from the screen at time (t_{b}). The middle letter in the upper left-hand corner has changed from B to A, and the left-hand number has changed from 1 to 0. The dashed rectangles illustrate the selected regions identified as having a differential change. Note also that the time has changed from 18 to 19 and a rectangle illustrates the selected change region. According to this embodiment, the information from the three selected regions is transmitted from personal computer 120 to the projector system 100 so that the projected screen image on screen 114 can be changed to match the image on screen 124. In this way, since the information from only the three selected regions is transmitted, much less data is required to be transferred via the wireless communication system.

Next, in FIG. 4C, the screen 124(c) is illustrated showing the next image sample time (t_{c}). In this image, the number three has changed in size and the clock in the lower right hand has also changed time from 19 to 20. Again, three selected regions are illustrated capturing the changed image information. Note that in alternate approach, instead of utilizing two regions for numbers 2 and 0 in the lower right hand corner, a single region can capture both numbers. Again, this information is transmitted as described above for the image at time (t_{b}).

In this way, it is possible to provide more efficient image transmission and thus provide high quality video projection, without requiring significant transmission bandwidth, or requiring significant calculations on the sending device.

Note that in these examples, at least two selected regions of change were identified that were non-overlapping in the image. However, in an alternative embodiment, the selected regions of change could be overlapping, at least in part. Although this may increase the data that is transmitted, it may provide for simpler algorithms in some respects. Furthermore, it may be that there are sub-regions of change identified in regions of change, such as when screen updates are occurring faster than even the subset of changed data can be transmitted.

Also note that in FIGS. 4B and 4C, the changed regions indicated by the dashed line are slightly larger than the actual rectangle including the changed pixels. Thus, the identified region of change can include an outer boundary of pixels that have not changed. However, to minimize the amount of data to be compressed and transmitted, the routine of FIG. 2 can select the region to be exactly large enough to encompass the changed pixels in the image.

Thus, in one embodiment a method is provided for transmitting images to a device. In some embodiments, the method may include reading data representing an image; identifying at least two spatially separated regions in said image which differ from a previously read image; and transmitting data from said at least two regions to the device. In this way, it may be possible to transmit images more efficiently with less bandwidth requirements, yet still provide an image that can show changing screens with good quality. The limited bandwidth requirements may be useful in wireless transmissions, while still maintaining quality image display.

Although the present disclosure includes specific embodiments, specific embodiments are not to be considered in a limiting sense, because numerous variations are possible. The subject matter of the present disclosure includes all novel and nonobvious combinations and subcombinations of the various elements, features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for transmitting images to a device, the method comprising:
reading data representing an image;
identifying at least two spatially separated regions in said image which differ from a previously read image; and
transmitting data from said at least two regions to the device.

2. The method recited in claim 1 wherein said image is a complete image from a screen, and the device is an image display device.

3. The method recited in claim 2 wherein said image is displayed on a screen of a first device separate from said image display device, said image display device being a projection device.

4. The method recited in claim 3 wherein said first device is at least one of a computer, a personal digital assistant, and a cell phone.

5. The method recited in claim 3 wherein said reading is performed on said first device.

6. The method recited in claim 1 wherein one of said at least two regions is a first size and a second of said at least two regions is a second size.

7. The method recited in claim 6, wherein the first size is different then the second size.

8. The method recited in claim 1 wherein a number of regions is as many as necessary to capture a predetermined amount of change in said images.

9. The method recited in claim 1 wherein a number of regions is limited to a maximum number.

10. The method recited in claim 1 wherein a number of regions is selected to minimize an amount of information needed to transmit differences in said images.

11. The method recited in claim 1 further comprising compressing data from said at least two regions before transmitting to an image display device.

12. The method recited in claim 11 further comprising uncompressing said data and then updating at least two regions on an image display from said display system, the at least two regions on said image display from said display system corresponding to the regions identified on said image.

13. The method recited in claim 1 wherein said at least two spatially separated regions are non-overlapping regions.

14. A method for transmitting images to an image display device, the method comprising:
reading data representing an image;
identifying at least two spatially separated, and non-overlapping, regions in said image which differ from a previously read image by a preselected amount;
transmitting data from said at least two regions to the image display device, without transmitting data from regions of said image in which said image differs from said previously read image by less than a predetermined amount.

15. The method of claim 14 wherein said predetermined amount is substantially the same as said preselected amount.

16. On a computer-readable storage medium, instructions executable by a computing device to transmitting images to an image display device, the medium comprising:
code for reading data representing a complete image from a screen of a first device coupled to said medium;
code for identifying at least two spatially separated, and non-spatially overlapping, regions in said image which differ from a previously read image by a predetermined amount; and
code for transmitting data from said at least two regions to the display device without transmitting data from regions of said image in which said image differ from said previously read image by less than said predetermined amount, said code for transmitting data including code for compressing information from said at least to regions and transmitting said information via electrical communication with said display device.

17. The medium recited in claim 16 further comprising code for interlacing data from said at least two regions.

18. The medium recited in claim 17 wherein said image display device is a projection device.

19. The medium recited in claim 18 wherein said electrical communication is wireless communication.

20. An image display device comprising:
an image-rendering device configured to receive transmitted image data representing an image; and
a lens element configured to project the image to a viewing surface;
wherein at least two-spatially separated regions in the image are identified as being different from a previously read image and wherein the image-rendering device is further configured to receive updated data for the at least two-spatially separated regions.

21. The device of claim 20, wherein the at least two-spatially separated regions are non-overlapping regions.

22. The device of claim 20, wherein the image-rendering device is configured to wirelessly receive the image data.

23. The device of claim 20, wherein the regions are of different sizes.

24. An image processing system comprising the device of claim 20 and an image source configured to transmit the image data.
